(19) United States
(12) Patent Application Publication
(10) Pub. No.: US 2021/0208537 A1
(43) Pub. Date: Jul. 8, 2021

(54) TIMEPIECE SETTING DEVICE WITH HARMONIC OSCILLATOR HAVING ROTATING WEIGHTS AND A COMMON RECOIL STRENGTH

(71) Applicant: Manufacture d'Horlogerie Audemars Piguet SA, Le Brassus (CH)

(72) Inventors: Pierre GOUJON, Neuchâtel (CH); Reymond CLAVEL, Yverdon-les-Bains (CH)

(21) Appl. No.: 16/650,423

(22) PCT Filed: Oct. 2, 2018
(86) PCT No.: PCT/IB2018/057658

§ 371 Date: Mar. 25, 2020

(30) Foreign Application Priority Data
Oct. 2, 2017 (CH) 01204/17

(51) Int. Cl. G04B 17/04; G04B 17/26

(52) U.S. Cl. CPC G04B 17/045; G04B 17/26

(57) ABSTRACT

The invention relates to a regulator device (1) including a harmonic oscillator, intended to be integrated into a watch with at least two weights (2.1, 2.2, 2.3, 2.4) mounted so as to pivot, a drive means (3) rotated by the gear train of the watch, a connecting element (4) kinematically connected to the drive means (3) in a substantially orthoradial direction and coupled to the oscillating weights, and a return elastic element arranged to provide a common return force on the pivoting weights and tending to urge the connecting element (4) toward the axis (3a) of the oscillator.

### TECHNICAL FIELD

The present invention has for subject matter a regulator device based on a harmonic oscillator with a plurality of rotating weights and a common return force, intended to be integrated into a timepiece, in particular into a wristwatch. Embodiments of the invention include in particular oscillators with two or more degrees of freedom in which an element follows a substantially circular or elliptical periodic trajectory when acted on by a central return force. These oscillators are also known as “isotropic harmonic oscillators”.

### PRIOR ART

Efforts aiming to produce an adjusting member not needing to be coupled to an escapement have already been made at various times since the existence of escapement type mechanical timepiece movements. One recent example of this kind of effort is the document WO2015/104692 that furthermore includes a structured review of numerous theoretical approaches for producing a harmonic oscillator of this sort, as well as theoretical bases of the physics of an oscillator of this kind.

Another example is the document EP3054358 which discloses a timepiece oscillator including a rigid frame, a plurality of distinct primary resonators out of phase temporally and geometrically and each including at least one inertial weight urged towards said frame by an elastic return means, coupling means arranged to enable the interaction of said primary resonators, and drive means arranged to drive said inertial weights with the aid of a control means. This device produces a specific embodiment of an isotropic harmonic oscillator in which said primary resonators are rotary resonators each equipped with its own return means and are arranged so that the axes of the articulations of any two of said primary resonators and the articulation axis of said control means are never coplanar. Although this proposal is more detailed, the specific construction proposed imposes a certain number of limitations, in particular concerning the position of the axes of the articulations of the primary resonators and of the control means and the plurality of return means each necessitating adjustment.

The document FR6308310009 discloses a means for producing an isotropic harmonic oscillator that is not usable in a wristwatch, however.

The Swiss patent application CH00679/17, which originates from the applicant of the present patent application and the content of which is in its entirety incorporated by reference into the present patent application, discloses a timepiece mechanism regulator device based on an isotropic harmonic oscillator, intended to be integrated into a timepiece.

Despite the fact that a plurality of prior art solutions exist for producing an adjusting member based on an isotropic harmonic oscillator, those solutions are not completely satisfactory, in particular where the complexity of construction and of adjustment, their compactness and the accuracy of operation are concerned.

In particular, the oscillator described in the document EP3054358, which includes a plurality of independent rotary primary resonators, is difficult to adjust because of the difficulty of identifying on which parameter to operate between the stiffnesses of the return elastic elements and the moments of inertia of the pivoting weights, with a risk of accentuating the instability by attempting to adjust the natural frequency. Moreover, the variants with four oscillators that enable the stability of the system to be improved are bulky and difficult to integrate into a timepiece movement.

Moreover, in an oscillator of the above kind using a plurality of rotary resonators, the circular arc trajectory of the points of articulation of the links on the balance wheel is a cause of instability: for a circular theoretical trajectory of the central control means, the zero speed and maximum speed points of said articulation points are not located at an equal distance from one another, and the braking distance is different from the acceleration distance, with the result that the inertia perceived by said drive means in the acceleration phases is not identical to that of the deceleration phases. The transverse movement of the central control means with reference to the direction of the links and the variation of the orbital radius of the connecting element further accentuate this dissymmetry.

This imbalance disturbs the trajectory of the connecting element and, to limit the effects thereof, imposes dimensional constraints for example at the level of the length of the links, the radius of the pivot point of the links and the angular amplitudes of the balance wheel. This dissymmetry may also be compensated by disposing two balance wheels symmetrically with reference to the axis of the oscillator. It would be preferable to be able to free oneself from at least some of these constraints, in particular in order to limit the number of rotary balance wheels, to render the operation of the system visible by reducing the frequency and increasing the amplitude of the oscillations and/or the inertia of the balance wheel, to improve the stability of the oscillator, and to limit the general overall size of the regulator member and facilitate its integration.

Moreover, the circular trajectory of the articulation points of the links and the variations of the orbital radius of the central control element caused by the variations of drive torque are a source of deterioration of the isochronism of an oscillator of the above kind. The circular theoretical movement of the central control element is broken down into a plurality of linear theoretical movements of the articulation axes of the transmission means on the balance wheels that correspond to the movement of the projection of the central control element onto the axes parallel to the links. When the drive torque increases, the orbital radius of the central control element increases as does the angular amplitude of the balance wheel so that the transverse component, with reference to the links, of the movements of the articulation axes becomes non-negligible. The tangential speed of the articulation point becomes significantly greater than that of its projection onto the axis defined by the corresponding link and the perceived inertia, which would be that of a weight with a purely linear movement, increases. This results in a variation of the frequency of the oscillator as a function of the drive torque that imposes limitation of the angular amplitude of oscillation of the weights so as not to deteriorate the isochronism.

### BRIEF SUMMARY OF THE INVENTION

The object of the present invention is to remedy at least partly the disadvantages of the prior art devices by proposing an isotropic harmonic oscillator the integration of which into a timepiece movement and the adjustment of which are simplified and the performance and the stability of which are improved.

To this end, the present invention proposes timepiece mechanism regulator devices based on an isotropic harmonic oscillator of the aforementioned type that is distinguished by the features stated in claim 1. The regulator device 1 according to the invention generally comprises at least one return elastic element arranged to produce a return force common to at least one subset of said weights. The weights are advantageously not each equipped with their own return means urging them toward the structure and advantageously do not each form a distinct resonator, so that it is possible to avoid some of the aforementioned disadvantages of the prior art devices, while benefiting from a simple construction using weights rotatably mounted on the rigid frame of the regulator device.

In a first preferred embodiment of the regulator device according to the present invention, said return elastic element is formed by the drive means, which produces said common return force by exerting a substantially radial force on the connecting element tending to return it toward the axis of the oscillator. A drive means of this kind enables simplification of the construction and adjustment of the regulator device.

In a second preferred embodiment of the regulator device according to the present invention, said return elastic element is formed by the transmission means. This embodiment may be produced by flexible arms having a stiffness chosen so as to be able to serve simultaneously as transmission means and return elastic means for the weights. Through these measures, the regulator device of a timepiece mechanism can be arranged in a particularly simple and effective manner, in particular by being produced in a monolithic manner.

In a third preferred embodiment of the regulator device according to the present invention, the regulator device comprises weights coupled elastically two-by-two. A return elastic element is situated between the two weights of each pair of weights. This embodiment enables production of a floating oscillator the neutral position of which is not defined with reference to the frame but with reference to the position of the connecting element, thereby correcting the dissymmetry caused by the lateral movement of this connecting element with reference to each transmission means. This configuration has another advantage, for identical rotating weights, of doubling the energy of the system by doubling the deformation of the elastic element and the relative speed of the weights. This enables reduction of the frequency of the oscillator to render its oscillations more visible or, alternatively, reduction of the size of the rotating weights to facilitate the integration of the oscillator. With identical characteristics, the angular amplitude of the oscillations of the weights with reference to the frame is divided by two which enables improvement of the isochronism in the case of variation of the drive torque.

In a fourth preferred embodiment the regulator device comprises two, preferably coaxial, weights elastically coupled by a return elastic element situated between its two weights and connected to the connecting element by substantially perpendicular transmission elements. In this configuration the two weights are out of phase by a quarter-period in the frame of reference of the frame whilst being in phase opposition in the imaginary oscillator frame of reference that they form between them. This configuration has the same advantages as the third embodiment with the additional advantage of being able to produce an oscillator including only two superposed rotating weights, which also enables a spectacular oscillator to be imagined with weights of large size oscillating at a low frequency or a very compact oscillator that is easy to integrate.

Moreover, the invention also concerns a mechanical timepiece movement and a timepiece including at least one regulator device according to the present invention.

Other features, as well as the corresponding advantages, will be clear from the dependent claims and from the following description disclosing the invention in more detail.

### BRIEF DESCRIPTION OF THE FIGURES

The appended drawings represent diagrammatically and by way of example a plurality of embodiments of the invention.

FIGS. 1a 1b and 1c show different configurations of a first embodiment of a timepiece mechanism regulator device according to the present invention.

FIG. 2 shows a schematic view of a second embodiment of a regulator device according to the present invention.

FIGS. 3a to 3l show, in different positions, two configurations of a third embodiment of a regulator device according to the present invention.

FIGS. 4a to 4f show, in different positions, a fourth embodiment of a regulator device according to the present invention.

FIGS. 5a to 5c represent two variants of a drive means including an elastic element intended to exert a return force on the connecting element. FIG. 5c is a section on the plane A-A in FIG. 5b.

### EXAMPLE(S) OF EMBODIMENTS OF THE INVENTION

The invention will now be described in detail with reference to the appended drawings showing by way of example a plurality of embodiments of the invention.

The present invention relates to a regulator device of a timepiece mechanism including an isotropic harmonic oscillator, the device being intended to be integrated into a timepiece.

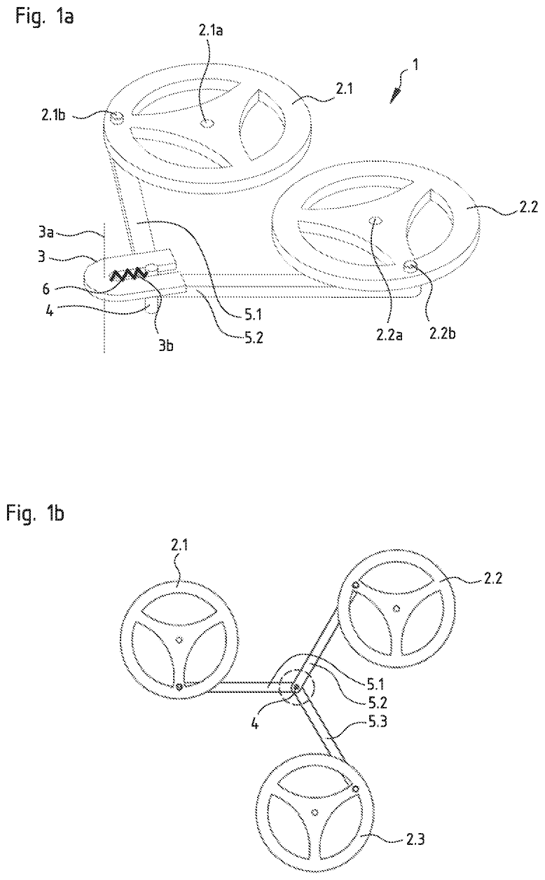

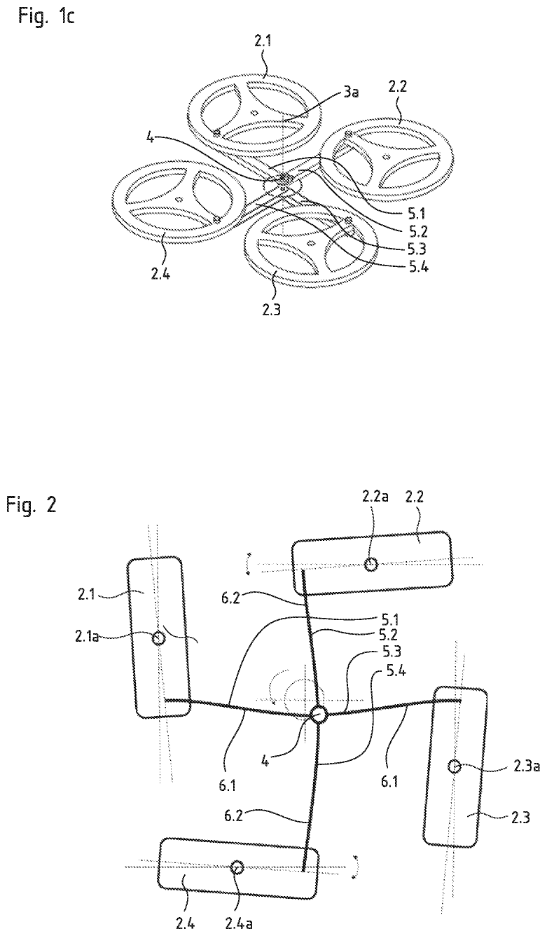

FIG. 1a shows schematically and by way of example a first embodiment of a device of this kind. This regulator device 1 includes a rigid frame, not shown, two weights 2.1, 2.2 formed by timepiece balance wheels mounted on said rigid frame to rotate about rotation axes 2.1a, 2.2a. The regulator device 1 further includes a drive means 3 adapted to be driven in rotation by the movement of said timepiece about an axis 3a of the oscillator. The drive means 3 includes a groove 3b extending in a substantially radial direction with reference to the axis 3a of the oscillator and in which is housed a connecting element 4 adapted to be moved along the groove and here taking the form of a pin. The groove is arranged to guarantee a minimum eccentricity of the connecting element in order to enable starting of the regulator device. The connecting element 4 is therefore free to move in translation in a substantially radial direction with reference to the axis of the oscillator and passing through the connecting element 4 while it is kinematically connected to the drive means 3 in a substantially orthoradial direction with reference to the axis 3a of the oscillator and to the position of the connecting element 4. The regulator device 1 further includes transmission means 5.1, 5.2 coupled, on the one hand, to said connecting element 4 and, on the other hand, to said weights 2.1, 2.2. Here the linking means 5.1, 5.2 take the form of links interconnected in a pivoting manner at one end by means of the connecting element 4 and mounted to pivot at their other end on the weights 2.1, 2.2 by way of articulation axes 2.1b, 2.2b.

In the context of the invention, by “orthoradial direction” is meant a direction perpendicular to the radial direction with reference to the axis of the oscillator passing through the connecting element 4.

The masses 2.1, 2.2 are placed on said rigid frame in such a manner that the two rigid links 5.1, 5.2 are oriented substantially perpendicularly to one another and so as to be perpendicular to the radial direction passing through their respective articulation axes 2.1b, 2.2b when the connecting element is centered on the axis 3a of the oscillator. The weights 2.1, 2.2 are balanced in rotation about their axis so that the oscillator remains insensitive to linear accelerations.

The regulator device according to the invention further includes a return elastic element 6 tending to return the connecting element toward the axis 3a of the oscillator. In the first embodiment the return elastic element 6 is situated at the level of the drive means 3 as schematically represented in FIG. 1a. This particular arrangement enables production of a return force common to both of the weights 2.1, 2.2 via the connecting element 4 and the transmission means 5.1, 5.2. The return elastic element 6 has an elastic constant K matched to the target stabilized rotation frequency and adapted to produce a linear return force.

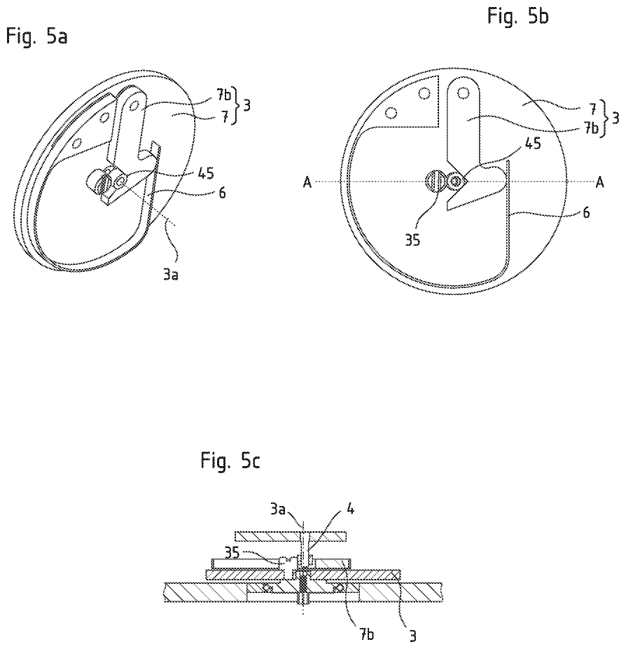

FIGS. 5a to 5c show two embodiments of a drive means 3 including a return elastic element 6 and that can be integrated into a regulator device according to the first embodiment. The drive means 3 includes a plate 7 driven in rotation by the gear train of the timepiece about the axis 3a of the oscillator. The drive means 3 also includes a return elastic element 6 in the form of a leaf spring fixed at one end to the plate 7 and exerting a substantially radial return force tending to return the connecting element 4 toward the axis 3a of the oscillator. The connecting element 4 cooperates, for example via a bushing 45, with a V-shape notch 45 formed either directly on the leaf spring or, as shown, on a lever 7b pivoted on the plate 7. The lever 7b enables a connecting element 4 to be guided on a substantially radial trajectory with reference to the drive means 3 and to the axis 3a of the oscillator. An eccentric 35 enables adjustment of the rest position of the connecting element when the oscillator is stopped. The return elastic element 6 integrated into the drive means 3 produces in this case a return force common to all the weights.

It emerges from the description of the regulator device shown in FIG. 1a that as soon as the energy source of the timepiece is activated the driving of the gear train causes rotation of the drive means 3 which in turn causes movement of the connecting element 4. The two-dimensional plane movement of the connecting element 4 is broken down into two orthogonal linear movements transmitted via the transmission means 5.1, 5.2 to the weights 2.1, 2.2, which start to oscillate. The return elastic element 6 exerts a substantially radially oriented linear return force toward the axis 3a of the oscillator. Because of the effect of the rotation of the drive means 3, the substantially radial guiding of the connecting element 4 with reference to the drive means 3 and the linear and isotropic central return force exerted on the connecting element 4 connected to the oscillating weights, the connecting element 4 therefore describes a substantially circular or elliptical trajectory at a defined frequency that stabilizes the rotation speed of the gear train.

The regulator device according to the first embodiment described hereinabove enables simplification of production and facilitation of calibration and adjustment of an isotropic oscillator, given that it includes only one return elastic element.

FIGS. 1b and 1c show variants of the first embodiment of a clock mechanism regulator device according to the present invention. FIG. 1b shows an oscillator including three weights 2.1, 2.2, 2.3 connected to the connecting element 4 by transmission means 5.1, 5.2, 5.3 in the form of links disposed at an angle of approximately 120′ to one another. FIG. 1c shows an oscillator including four weights 2.1, 2.2, 2.3, 2.4 connected to the connecting element 4 by transmission means 5.1, 5.2, 5.3, 5.4 in the form of links disposed at an angle of approximately 90° to one another. The proposed configuration with four balance wheels, in which two opposite balance wheel have opposite rotation speeds, enables compensation of angular accelerations.

It is possible to imagine an oscillator including more rotating weights and/or to vary the geometrical disposition of the weights.

FIG. 2 shows a schematic view of a second embodiment of a timepiece mechanism regulator device according to the present invention. In the configuration shown the oscillator includes four weights 2.1, 2.2, 2.3, 2.4 rotatably mounted on the rigid frame and disposed in a similar manner to those in FIG. 1c. In an original manner, the return elastic element 6 of this regulator device is formed by the transmission means, which produce a common return force on the weights. The transmission means 5.1, 5.2, 5.3, 5.4 are produced by a cruciform monolithic flexible structure the arms of which have a stiffness chosen so as to serve simultaneously as transmission means and elastic return means for the weights 2.1, 2.2, 2.3, 2.4. The transmission is effected mainly in the longitudinal direction of the flexible arms and the return force is created mainly by flexing of the flexible arms in the transverse direction. Consequently, the common return force is produced in this case by the flexible arms that serve simultaneously as the transmission means between the weights and the connecting element 4, the coupling means of the opposite weights, the elastic return means of the transverse weights and, in the case where they are monolithic with the weights, the articulation means at their ends fixed to the weights. In this case the ends of the flexible arms of the cross could advantageously be connected to the corresponding weights via a neck having a reduced section relative to the section of the transmission means in order to produce a pivot connection. The common return force exerted by the flexible arms may be adjusted for example via the thickness, height and/or length of the arms and by the material of which they are made. In particular, it is possible to use one of the drive means 3 described hereinabove in which the return spring could be eliminated or calibrated differently.

The regulator device according to the second embodiment may advantageously be produced so that the weights 2.1, 2.2, 2.3, 2.4 and the flexible arms forming the transmission means are produced by a monolithic part, as shown schematically in FIG. 2. This has the advantage of offering the possibility of producing a very flat adjustment member. It is obviously possible to produce the regulator device using conventional techniques, that is to say to use separate parts for the weights and the flexible cross, and to produce the articulations of the arms on the weights in the traditional manner with the aid of pivots. The embodiment shown with four oscillating weights is only one advantageous configuration of an oscillator of this kind. The present invention also covers configurations including a flexible cross connected to three or more weights. The crosses having an even number of arms may be produced with identical flexing segments coupling two opposite weights to one another. The pivots of the weights could interchangeably be produced in the traditional manner or with the aid of flexible elements, for example necks of reduced section, the stiffness of which would remain low compared to that of the flexible cross.

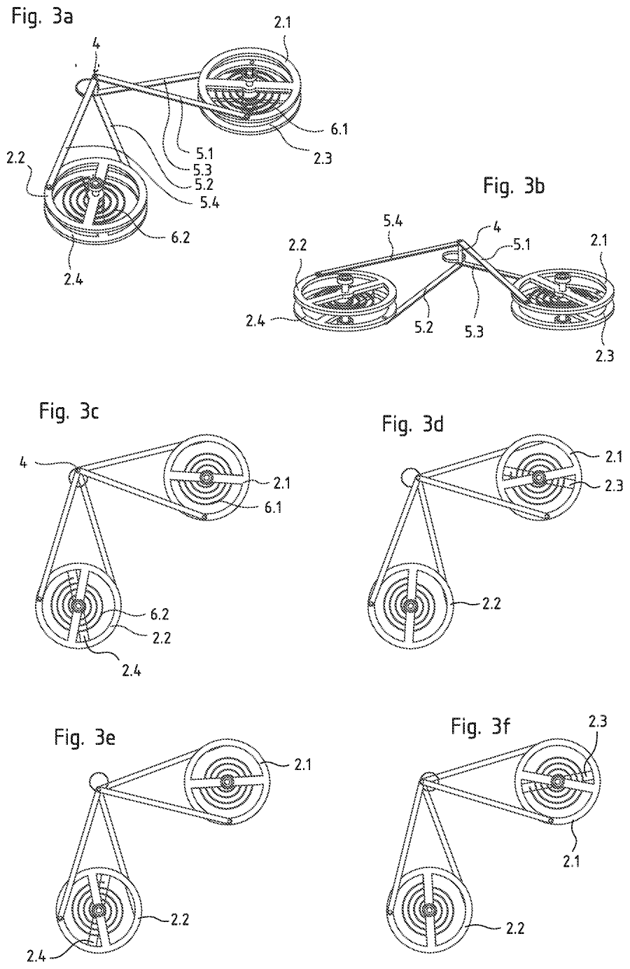

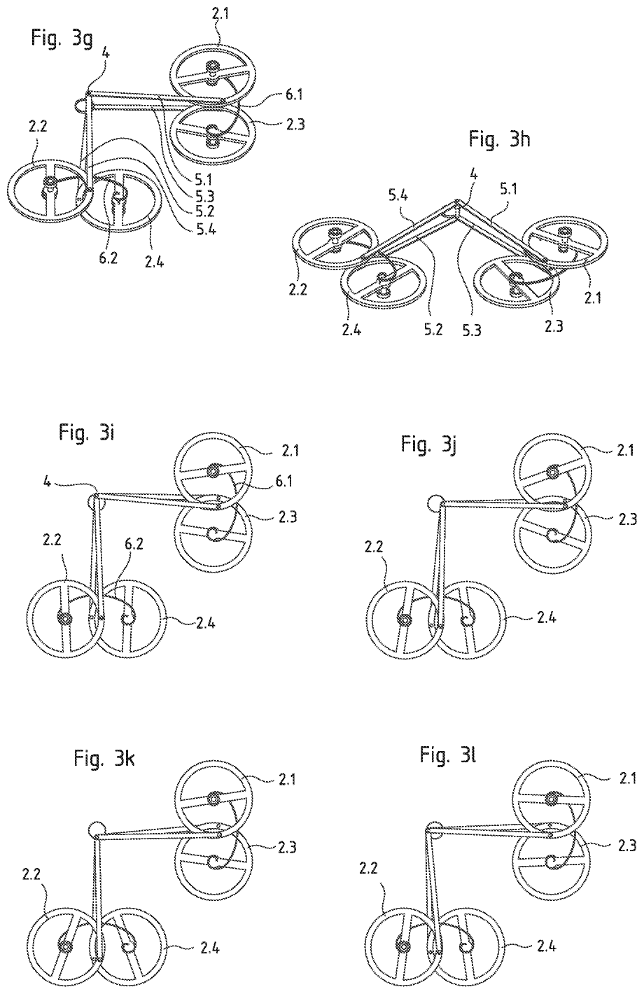

FIGS. 3a to 31 represent in different positions two variants of a third embodiment of a regulator device according to the present invention. The drive means 3 of this regulator device is shown only symbolically by the rotating plate. This regulator device comprises two pairs of weights 2.1, 2.3, 2.2, 2.4 in the form of balance wheel, each pair of weights including a return elastic element 6.1, 6.2 situated between its two weights. Moreover, each weight 2.1, 2.3, 2.2, 2.4 of the pairs of weights is connected via a transmission means 5.1, 5.3, 5.2, 5.4 in the form of links to the connecting element 4. The weights are balanced and disposed in such a manner that the transmission means of one pair are disposed at substantially 90° relative to those of the other pair. The links of a pair of weights are articulated at substantially diametrically opposite points of the balance wheel, which causes oscillation in the opposite direction of the two balance wheel of a given pair of weights. The pivoting in the opposite direction of the two balance wheel of a pair enables reduction of the sensitivity of the regulator device to angular accelerations.

FIGS. 3a to 3f show a first variant in which the balance wheels of each pair are coaxial and elastically coupled to one another by return elastic elements 6.1, 6.2 in the form of spiral springs.

FIGS. 3g to 3l represent a second variant in which the balance wheels of a pair are coupled by an elastic return element 6.1, 6.2 in the form of a leaf spring and juxtaposed so that their respective transmission means are substantially parallel.

In both variants the pairs of weights are disposed in such a manner that the transmission means of one pair are substantially orthogonal to those of the other pair, thus enabling the plane movement of the connecting element 4 to be broken down into two quasi-linear components of the articulation points of the links on the balance wheel. The return elastic elements 6.1, 6.2 are calibrated or adjusted in such a manner that the connecting element 4 is located on the axis 3a of the oscillator when the two return elastic elements are not deformed. When the connecting element is located in an eccentric position relative to the axis 3a of the oscillator the return elastic elements 6.1, 6.2 exert a torque tending to return the balance wheels into a mutual relative angular position by transmitting to the connecting element 4 forces the resultant of which is a centripetal force tending to return the connecting element 4 toward the axis 3a of the oscillator.

In an original manner, each pair of balance wheels is floating with reference to the frame and its neutral position oscillates in such a manner as to follow the movements of the connecting element 4. The neutral position of the weights is therefore no longer defined with reference to the frame but with reference to the connecting element. A first advantage of this third embodiment is to correct the isochronism errors resulting from the dissymmetries caused by the relative lateral movement of the connecting element 4 relative to the articulation points of the transmission means on the weights, caused by the circular trajectory of the articulation points and by the variations of the orbital radius as a function of the drive torque.

This configuration has another property of doubling the energy of the system without modifying the angular amplitude of the oscillation of the weights with reference to the frame or alternatively, for the same energy, of enabling reduction of this amplitude by half or reduction of the size of the balance wheels. In fact the angular deformation of the elastic element is doubled for the same amplitude of oscillation of the weights with reference to the frame. This results in advantages in terms of isochronism due to the improved compliance with the required theoretical rectilinear trajectory for the articulation points of the links as well as in terms of ease of integration due to the greater relative rotation speed of the weights which enables the size thereof to be reduced without modifying the inertia of the system.

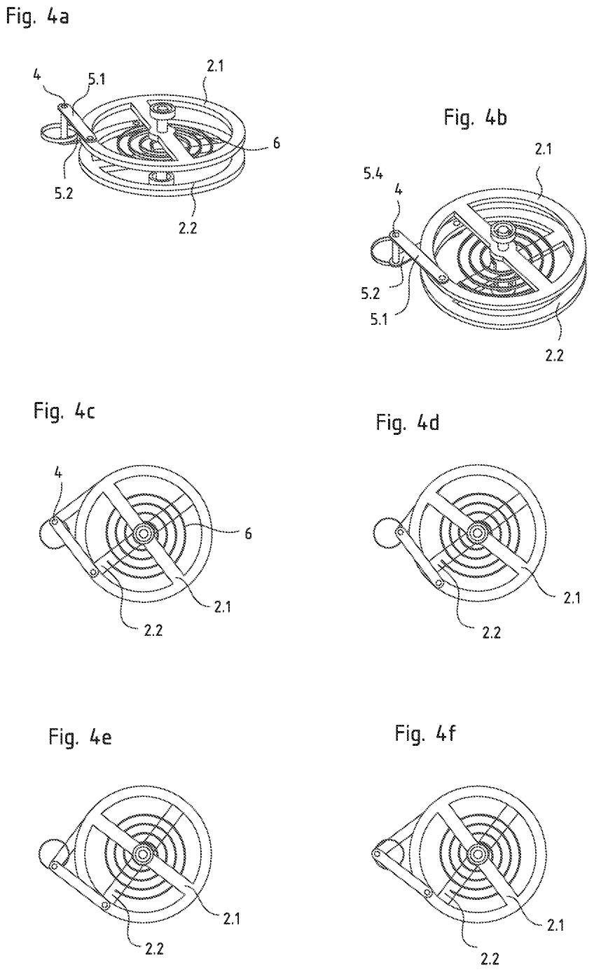

FIGS. 4a to 4f represent a fourth embodiment of a regulator device of a timepiece mechanism, comprising two, preferably coaxial, weights 2.1, 2.2 elastically coupled by a return elastic element 6 situated between the two weights 2.1, 2.2. The two weights are connected to the connecting element by substantially perpendicular transmission elements 5.1, 5.2 when the elastic elements 6 is at rest, for example in the configurations represented in FIGS. 4c and 4e. In this configuration the articulation points of the connecting elements on the weights are offset 90° with reference to the pivot axis of the weights. The result of this arrangement is that the two oscillating weights are out of phase by a quarter-period in the frame of reference of the frame whilst being in phase opposition in the imaginary oscillating frame of reference that they form with one another. The return force of the connecting element is produced, on the one hand, by the radial resultant, with reference to the pivot axis of the weights, of the actions of the two connecting elements and, on the other hand, by the radial component with reference to the axis of the oscillator of the action of the connecting element on the drive means.

This configuration has the same advantages as the third embodiment with the additional advantage of enabling production of an oscillator including only two rotating weights that also enables a spectacular oscillator to be imagined with weights of large size oscillating at a low frequency or a very compact oscillator to be imagined that is easy to integrate. The superposition of the oscillating balance wheels out of phase by one quarter-period and where applicable of the oscillating platform out of phase by one eighth-period enables an original visual effect to be produced.

It follows from the above description that the timepiece mechanism regulator devices according to the second, third and fourth embodiments all include a return elastic element situated between at least two of the weights 2.1, 2.2, 2.3, 2.4 and arranged in such a manner as to produce a common return force for at least one subset of the weights 2.1, 2.2, 2.3, 2.4. As in the first embodiment, this arrangement enables simplification of the construction, calibration or adjustment of a device of this kind compared to those of the prior art. It is obviously possible to combine the various embodiments with one another, in particular using a drive means similar to that shown in FIGS. 5a to 5c in embodiments 2 to 4.

Moreover, because of the limited angular amplitude of the oscillations, the pivot connections of the oscillating weights to the frame and of the connecting elements to the weights may be produced in a traditional manner or in a monolithic manner with deformable flexible elements. In the case of a monolithic construction, the stiffness of the flexible elements providing the pivot connections remains low compared to that of the return elastic element.

In all the embodiments of the regulator device of a timepiece mechanism described hereinabove the device comprises at least one return elastic element 6, 6.1, 6.2 arranged to produce a return force, either on at least one subset of or on all of said weights 2.1, 2.2, 2.3, 2.4. The return elastic elements are not situated between the weights and the rigid frame and none of the weights has a particular return elastic member, so as to form with that weight a distinct resonator.

The present invention also concerns a timepiece movement integrating a regulator device of the above kind and a timepiece including a movement of that kind.

### REFERENCE SYMBOLS

1 regulator device
2.1, 2.2, 2.3, 2.4 weights, balance wheels
2.1a, 2.2a, 2.3a, 2.4a weight rotation axes
2.1b, 2.2b articulation
3 drive means
3a drive means rotation axis
3b groove
4 connecting element
5.1, 5.2, 5.3, 5.4 transmission means
6, 6.1, 6.2 return elastic element
7b lever
7c leaf spring
35 eccentric
A-A section plane (FIG. 5c)

1. A regulator device comprising an isotropic harmonic oscillator, intended to be integrated into a timepiece, said regulator device including:
at least two distinct weights intended to be mounted to pivot with reference to a frame of the timepiece and balanced on their pivot axes,
a drive means adapted to be driven in rotation by the movement of said timepiece about an axis of the oscillator,
a connecting element kinematically connected to the drive means in a substantially orthoradial direction with reference to the axis of the oscillator and to the position of the connecting element and free to move in translation in a substantially radial direction,
transmission means connecting the connecting element to the weights,
wherein the regulator device includes at least one return elastic member arranged to produce a return force common to at least one subset of said weights tending to return the connecting element toward the axis of the oscillator.

2. The regulator device as claimed in claim 1, wherein the at least one return elastic member is common to all the weights.

3. The regulator device as claimed in claim 1, wherein the drive means includes a lever arranged to guide the connecting element on a substantially radial trajectory with reference to the axis of the oscillator.

4. The regulator device as claimed in claim 1, wherein the drive means includes an eccentricity adjuster device.

5. The regulator device as claimed in claim 2, wherein the at least one return elastic element (6) is situated on the drive means (3) in such a manner as to exert a substantially radial return force on the connecting element (4).

6. The regulator device as claimed in claim 1, wherein the at least one elastic element (6, 6.1, 6.2) is situated between two weights (2.1, 2.2, 2.3, 2.4).

7. The regulator device as claimed in claim 1, wherein the at least one return elastic element is a transmission means.

8. The regulator device as claimed in claim 7, in which the transmission means connecting the weights to the connecting element and the at least one return elastic element is/are produced by a structure with flexible arms serving simultaneously as transmission means and as elastic return means for the weights.

9. The regulator device as claimed in claim 8, wherein the at least one return elastic element is a cross including flexible arms connected to at least three weights.

10. The regulator device as claimed in claim 9, wherein the cross and the weights are produced monolithically.

11. The regulator device as claimed in claim 6, wherein it includes at least two pairs of weights, the weights of a pair being elastically coupled by an elastic element.

12. The regulator device as claimed in claim 11, in which the weights of a pair are connected to the connecting element (4) by substantially parallel transmission means.

13. The regulator device as claimed in claim 2, comprising a pair of weights elastically coupled by an elastic return element, the transmission means connecting the weights to the connecting element being substantially orthogonal.

14. The regulator device as claimed in claim 13, in which the weights are coaxial.

15. The regulator device as claimed in claim 1, wherein includes no elastic return means intended to be placed between the weights and the frame.

16. The regulator device as claimed in claim 1, in which the transmission means are articulated to the corresponding weights by pivot connections formed by necks having a reduced section relative to the section of the transmission means.

17. A timepiece including a regulator device as claimed in claim 1.
